(19) United States
(12) Patent Application Publication
(10) Pub. No.: US 2004/0199603 A1
(43) Pub. Date: Oct. 7, 2004

(54) Method and system for allowing cross-communication between first and second areas of a primary web page

(76) Inventors: Sivan Tafla, Tikva (IL); Saar Safra, Hasharon (IL)

Correspondence Address: NATH & ASSOCIATES, 1030 15th STREET, 6TH FLOOR, WASHINGTON, DC, 20005, US

(21) Appl. No.: 10/483,181

(22) PCT Filed: Jul. 2, 2002
(86) PCT No.: PCT/IL02/00538

(30) Foreign Application Priority Data
Jul. 9, 2001 (IL) 144207
Aug. 16, 2001 (IL) 144942

(51) Int. Cl. G06F 15/16

(52) U.S. Cl. 709/217

(57) ABSTRACT

A method, web server (13) and web browser (15, 70) for allowing cross-communication between first and second areas of a primary web page respectively sourced by first and second content providers. First and second areas of the primary web page are allocated, and in the second area of the primary web page there is embedded a link to a secondary web page provided by the first content provider and containing a link to content from an unrestricted content provider, thus enabling any content thereof to be loaded to the second area within the primary web page. The primary web page may be encoded using a web marker language and a first object may be located at a desired location with respect to the web page, so that when the first object is displayed by a client machine (11) having a web browser (70) in mutual association with the web page the first object is spatially coordinated with a second object in the web page. Code is included in the web marker language of the web page, for displaying a reference object. The code includes a name identifying the reference object or being associated therewith and being set to a name that is known to identify the first object. Upon uploading the web page to the client machine that receives the first object, the web browser displays the first object at a display coordinate of the reference object. The invention discloses a modified web browser or an agent for use in association therewith for rendering web pages that contain references to named external objects that may be downloaded from an independent content provider.

### FIELD OF THE INVENTION

This invention relates to in-line frames (I-Frames) within web pages.

### BACKGROUND OF THE INVENTION

In-Line Frames are frames that appear within an HTML page. Visually, they resemble table cells, but the frame content is not text on the host HTML page, but rather a completely separate page that may be downloaded from a different source than the host page. The basic HTML construct for an in-line frame is:

<FRAME SRC=“infl.html”></IFRAMB>

IFRAME is the HTML command that invokes an in-line frame at the current location of the host page, SRC denotes the source for the page, and /IFRAME ends the command. Typical uses of I-Frames are to allow a composite web page to be segmented and to display different aspects of the web page content in each segment. For example, an on-line newspaper may display a list features and articles in a scrollable frame at an edge of the web page, whilst the article itself is displayed in a main frame of the web page. Additional frames may display advertisements or other user-selectable options. In such case, clicking on a link in the list of features, causes the web browser in the client's machine to fetch the web page corresponding to the selected feature or article and display it in the main frame of the web page.

Frequently, the content displayed in different frames of a web page is derived from different sources. For example, in the case of the on-line newspaper described above, the list of features and the content thereof may be HTML pages stored on a web server owned by the on-line newspaper web provider, while auxiliary content such as advertisements may be derived from one or more independent ad servers.

In such case, there exists the danger that if the web browser on the client machine allowed cross-communication between different frames on the same host page, sensitive data entered into one frame for reading by a first web provider might also be communicated to a second web provider being the source of the second frame. Normally this must be prevented since were such cross-communication between frames to be unrestricted, an unscrupulous web provider could display a web page passing itself off as the web page of a reputable service provider. An unknowing end-user, thinking that a reputable link had been downloaded might then enter sensitive data such as credit card details, thinking this was destined for the reputable service provider, whilst in fact it would be channeled to the unscrupulous web provider. To guard against such eventuality, web browsers are designed to prevent cross-communication between frames emanating from different service providers, i.e. whose sources are different. On the other hand, no such restriction obtains for frames whose content is derived from the same source.

EP 0 974 900 published Jan. 26, 2000 to Hewlett-Packard Company and entitled “Method for communicating between frames within a web browser window” discloses a web browser based application that allows communications between programming language driven frames and HTML or CGI/HTML driven frames within the same browser window. A Web browser computer on a network accesses the Web browser based application, which is loaded onto a Web server computer, called a remote support node. A port manager within the Web browser based application, is used to coordinate communications between the programming language frame and the CGI/HTML frame. The port manager, which maintains a list of all Web browser computers currently logged onto the application, can send the same message to all logged on computers. Thus, changes made by one user to the data in the application can be immediately communicated to all active browsers logged onto the application.

Thus, it appears that a principal object of EP 0 974 900 is to address the problem of simultaneous markup of a common source document by different users each operating respective web browsers. The different frames in this case are actually on different machines and are controlled by different web browsers. Moreover, special software (i.e. the port manager) is required at the web server and the content displayed in each of the frames is clearly derived from an identical source hosted by the same service provider.

Clearly, a much more severe security issue is presented when it comes to serving HTML web pages from independent sources to end-users' browsers. In contrast, flexibility is the name of the game when it comes to browser competition and capabilities. Therefore, there is a very thin line between enabling content creators to be flexible from a visual and content standpoint, and making sure that delinquent users do not use this flexibility for their improper intentions.

A web domain is the virtual representation of a content provider's physical web server that serves requested HTML web pages. Hence, a content provider can create an HTML web page, divided into two frames, where one frame presents content from one web domain, and the other frame presents content from a different web domain. For example, an HTML web page can show in one frame the homepage of Yahoo! (from domain www.yahoo.com) and on the other frame the homepage of eBay (from domain www.eBy.com). This flexibility was developed to enable web page creators to present their content while at the same time presenting ads (mostly banner-ads) from a centralized advertising system, such as but not limited to, DoubleClick, L90 etc. However, as noted above this flexibility can be used for malicious activities. Therefore, all web browsers (which are HTML containers) disable the option for communication between frames that their content derives from different web domains. For example, if we revert back to the example of the HTML web page that shows on one frame the homepage of Yahoo! and on the other frame the homepage of eBay, the two frames would not be able to exchange information, query each other about parameters, statuses, functions, content etc. because of the above-mentioned restriction embedded in the web browsers' security rules.

However, this restriction limits the flexibility of the system. For example, it prevents any content within the frame from communicating with the host page unless they are sourced from the same content provider server. Such cross-communication may, in fact, be desirable. Consider, for example, a host page that may be a manufacturer's home page (constituting a main content provider) and which contains a frame in which an interactive advertisement is to be displayed sourced by an ad server (constituting an auxiliary content provider). The advertisement may allow the end-user to click on one or more links for interacting with the manufacturer, for example to request further information or to register with a service provided thereby, and so on. In the absence of cross-communication between different frames in the host page, or between the host itself and any component frame, direct interaction of this kind is not impossible. This means that any legitimate and desirable interaction with the main content provider must be effected via the auxiliary content provider. This clearly imposes an additional burden on the auxiliary content provider and results in slower reaction to the end-user's queries.

It should also be understood that whilst so far frames are related to segments of the host page, they are not limited in the extent of the host page that they occupy. Conventionally, frames are used for placement of advertisement banners in the host page and in this case they occupy a fixed and dedicated area of the host page that is determined when the host page is designed. Since the banner thus reduces the amount of space in the host page that may be devoted to the main application, frames allocated to advertisement banners are invariably compact.

However, the frame can equally well be a separate layer that is displayed by the client machine's web browser superimposed on the host web page. For example, in WO 01/44969 published Jun. 21, 2001 in the name of the present applicant (corresponding to IL 133560 and IL 143320) there is disclosed a method for presenting an animated advertisement on a web page, in which a web server obtains a web page layer adapted to contain an animated advertisement content having at least one object adapted to run across a web page downloaded to a client computer connected to the web server without obscuring or disabling portions of the web page lying outside a boundary of the objects at any given instant of time. The web server then downloads the web page layer to the client computer for displaying the animated advertisement content in association with the web page. Preferably, the animated advertisement is displayed as a brief animated clip relating to a product or service to grab an observer's attention, and displaying a link to an advertisement stored in association with an advertisement web server associated with the product or service. This allows the observer to get further information relating to the product or service by clicking on the link. The animated advertisement thus serves as a teaser for enticing a user at the client machine to request an advertisement and the link serves as a reminder of the advertisement after termination of the teaser.

Such an approach requires cross-communication between the host page and the advertisement layer since, as the animated advertisement travels across the host page it obliterates, albeit only momentarily, the content of the host page. This can only be achieved if interaction between the host page and the animated layer is possible. This means, that for the host to provide the benefit of an animated advertisement as taught by WO 01/44969, the advertisement content must be stored on the same web server as the host page. Moreover, there are many occasions when varying advertisement content must be downloaded by the client's web browser, such as when advertisements are targeted to specific types of end-user depending on their different profiles. To achieve this flexibility has so far required that the web pages corresponding to each different advertisement content are all stored on the same web server as the host page. However, this militates against common practice where, as noted above, it is usual for advertisements to be sourced by an independent ad agency operating its own domain server. It also means, of course, that if the ad agency wishes to change the content of their advertisements, then each new page must be conveyed to every host for substitution in the host's web server. This significantly detracts from the convenience to the host as well as from the flexibility to the ad agency and discourages changes.

FIG. 1 is a pictorial representation showing the relationship between an advertiser and the various intermediaries that are responsible for conveying an advertisement to an end-user. Thus, it is assumed that an advertiser wishes to advertise a mobile telephone 1 so that it appears at an end-user's computer 2 either in an ad banner or as a floating ad. The advertiser, who might be the manufacturer or distributor of the mobile telephone 1, enlists a creative unit 3 such as Ad4Ever, Inc. the applicant of the present application. The creative unit 3 creates a computer-readable advertisement and conveys to an ad server 4 of which there are shown several in the figure. Thus, ad servers 4, 5 and 6 are provided by DoubleClick Inc., AdForce Inc. and Real Media, respectively. The ad servers 4, 5 and 6 convey advertisements to ad publishers 7, 8, 9 such as Lycos, Excite and Yahoo!, respectively.

In the case of the present invention, the creative unit 3 typically creates an animated advertisement for displaying the mobile telephone 1 and sells the animated advertisement to the customer, being one of the Ad Servers 4, 5 or 6. The publisher typically embeds an I-Frame in its own HTML page (constituting a host web page). Typically, each publisher works with one designated ad server and within the I-Frame there is a call to the designated ad server 4, i.e. DoubleClick. The end-user represented by the computer 2 surfs web pages belonging to a specific publisher e.g. Lycos 7 and downloads an HTML web page. The I-Frame therein calls directly to DoubleClick 4. Thus, on the same web page there is an area that receives content from the publisher 7 (Lycos) and there is another area that receives content from the ad server 4 (DoubleClick). If the ad server 4 wishes to send an advertisement created by the creative unit 3 to the end-user computer 2, then it sends a tag to the I-Frame and the tag sends a redirection call to the Ad4Ever server 3 for downloading the advertisement directly therefrom. Alternatively, as is explained below, the advertisements may be stored directly on the publisher's server, but in this case the problem to whose solution the invention is directed does not arise, although different problems arise as noted below.

FIG. 2 shows pictorially the flow of data between the various elements shown in FIG. 1. Thus, the end-user computer 2 requests an HTML web page from the publisher 7, i.e. Lycos. The HTML web page is sent from the publisher 7 to the end-user computer 2 and contains an embedded I-Frame for referencing an advertisement to be downloaded from the creative unit 3, i.e. Ad4Ever. The I-Frame requests the ad from the Ad4Ever server, which uploads it to the end-user computer so as to appear superimposed on the HAUL web page downloaded from the publisher.

Consider now a fraudulent web page operator who wishes to obtain a user's credit card number. In the absence of appropriate security provisions, such a web page operator could download a secondary HTML page that fraudulently mimics a known provider containing text boxes for entry of a user's personal details and credit card number and so completely overlays the host web page that only the fraudulent page is visible. The end-user has no reason to think that the web page does not emanate from a reputable source from which he or she wishes to purchase goods or services and so innocently enters his or her personal details and credit card number. If communication between the secondary HTML page and the host page were possible, the unscrupulous advertiser could then obtain the user's credit card details and use them fraudulently.

In practice, this cannot occur since communication between the host web page and any secondary web page emanating from a different source is prevented under Java design rules. Java is a registered trademark of Sun Microsystems Inc. However, within the advertisement scenario as described above with reference to FIGS. 1 and 2, this means that communication is prevented between the advertisement layer downloaded from the creative unit and the host web page downloaded from the publisher. This represents a limitation since the advertisement is in most cases the property of the proprietor of the host web page, who merely commissions the creative unit to create the advertisement on his behalf, owing to the need to have the work done professionally. This being the case, the proprietor of the host web page wants to receive any ordering details that are entered into the ad web page. In the prior art, this desideratum is typically addressed by storing the advertisement on the publisher's server, thus enabling both the host web page and the advertisement referenced thereby to be downloaded from the same server, thus allowing cross-communication between the two. But this is limiting since any changes made to the advertisement by the creative unit must be downloaded to each publisher.

It would therefore clearly be desirable to cross-connect between the host web page and the animated advertisement layer even when they derive from different content providers. This requirement applies not only to the specific case where animated advertisement layers are to be superimposed on a host page, but also to more general situations where cross-communication between two frames in the same host page or between a frame and the host page itself is desirable. However, currently no method exists for allowing this.

Yet another problem associated with superimposing web content from multiple independent sources appears not to have been addressed in the prior art. Most Internet pages are intended for displaying some data, which is critical for their publishers. Besides this critical data, many Internet sites provide also for the inclusion of advertisements in their web pages. It is important to note that the advertisement data (text, graphics, animation and any other form of multimedia) is usually joined to the web page from a foreign web server, such as an ad server.

When a web page containing an advertisement is downloaded, the ad server is contacted. Many ad servers keep a repository of users' profiles, based on which they can determine whether the surfer is a female or a male, what are her/his hobbies, surfing habits etc. This repository provides data for matching the advertisement to a particular web surfer. This way, two different surfers viewing the same web page may view different advertisements, which have been matched to their respective profiles accordingly. If the advertising data changes, this change will automatically be reflected in the respective web page reaching each user, without requiring any change in the web page downloaded.

A common way for publishing advertisements for the Internet is by providing for the inclusion of advertisement banners in the web pages. In such cases, a specified location of the web page is designated for displaying an advertising banner that is downloaded from a specified web server. Usually, the advertisement is prepared by an ad server on behalf of its client and the host web page includes a call to the ad server, which feeds an advertisement to the host web page at the specified location. Moreover, the need to allocate an area of the web page to the advertisement banner limits the area of the web page that is available for conveying other information specific to the web site. Thus, the web site must sacrifice some of its own valuable area in order to support the advertising banner.

Advertising banners are designed to appeal to the web surfer in the hope that the advertised product or service will be of sufficient interest so that he or she will be inclined to click on the banner and, by so doing, enter the referent web site. In fact, user reaction to static or multimedia based banners is very low and simply not comparable to other advertising and direct mail response rates.

Classical banners can convey only a simple static message. As noted above, usually all presentations are predefined and pre-created. To this extent, they are no different than an advertisement glued to a car or bus, except that they can be targeted by the ad server depending on the end-user's profile. They are further usually limited in the amount of information they can convey. For example, some portals limit the banner size to 9-12 kbytes.

As an alternative to displaying advertisements in banners, it is also known to display in association with a host web page an animated advertisement. Such an approach is described, for example, in WO 01/44969 published Jun. 21, 2001 in the name of the present applicant and entitled “Method and system for presenting an animated advertisement on a web page”. Such animated advertisements include at least one an animated object that is adapted to move with respect to the host page and is typically conveyed to the host page using layered technology.

Thus as described in WO 01/44969, a transparent web page layer is super-imposed over the web page, containing the animated advertisement having at least one object adapted to run across the web page without obscuring or disabling portions of the web page lying outside the boundary of the objects at any given instant of time. As the object moves relative to the web page, only those portions of the web page overlaid at any instant of time by the object are obscured, unless the animated object is translucent.

WO 01/44969 further proposes that a so-called “teaser” be downloaded by the client, preferably in the form of an animated advertisement as described above. The animation typically lasts only a few seconds so as to grab the user's attention and then disappears so as not to distract the user. Thereafter, it is frequently required that a link to the ad server stay on the previously displayed web page, which remains otherwise unchanged. Therefore, during this process, the user remains connected to the web page subject of his or her selection and is not re-directed to a web site of potentially no interest. However, if the user would like to receive further details relating to the product or service subject of the “teaser”, he or she can click on the displayed link, whereupon the web browser in the client machine re-directs the client machine to the requested web site. The displayed link thus serves as a permanent “reminder” of the brief animated advertisement clip previously displayed intermittently. Preferably, clicking on the “reminder” redisplays the brief animated advertisement clip in the form of a “main movie” including command buttons for allowing the user to interact with the displayed image.

Since the “reminder” must remain visible even after the “teaser” has vanished, it is clearly important that it appear at a location on the host web page that does not hide or overlay critical data thus possibly disabling functionality of the host page. If the advertisement layer is created by the same team as the web page itself, this presents no problem since the location at which the reminder must appear in the animated advertisement may be coordinated with the objects in the host page so as to ensure that the reminder is displayed at a location that does not obscure critical objects in the host page.

However, as noted above, most usually the advertisement layer and the web page are created by completely different entities. Moreover the web server that uploads the host page to the client machine cannot even know in advance what advertisement will be uploaded by the ad server to the pre-allocated location in the host web page. This presents a particular problem when the location is hard-coded inside the creative elements, thus limiting the creative elements to a predefined location on the user's browser.

There is therefore also a need to provide a mechanism that allows for spatially coordinating a first graphic object with respect to a second graphic object in web page that will allow a web browser to display the first and second graphic objects in any desired spatial association.

### SUMMARY OF THE INVENTION

It is therefore a first object of the invention to provide a method that allows legitimate cross-communication between independent areas of a web page sourced by different content providers.

It is a second object of the invention to provide a method for sharing advertisement graphics and animation between different host web pages in such a manner that an animation object does not permanently obscure critical content of the web page.

To this end there is provided in accordance with a first aspect of the invention a method for allowing cross-communication between a first area and a second area of a primary web page respectively sourced by first and second content providers, said method characterized by:

(a) allocating the first and second areas of the primary web page, and

(b) embedding in the second area of the primary web page a link to a secondary web page provided by the first content provider and containing a link to content from an unrestricted content provider, thus enabling any content thereof to be loaded to the second area within the primary web page.

In accordance with a second aspect of the invention there is provided a method for allowing cross-communication between a first area and a second area of a primary web page respectively sourced by first and second content providers, said method characterized by:

(a) accessing a primary web page containing a first area and a second area containing a link to a secondary web page accessible to said web server and containing a link to content from an unrestricted content provider, and

(b) uploading the primary web page to a client machine connected to the web server thus enabling said content to be loaded by a web browser in the client machine to the second area within the primary web page.

In accordance with a third aspect of the invention there is provided a method for allowing cross-communication between a first area and a second area of a primary web page respectively sourced by first and second content providers, said method characterized by:

(a) downloading from a web server controlled by the first content provider a primary web page containing a first area and a second area containing a link to a secondary web page accessible to said web server and containing a link to content from an unrestricted content provider, and

(b) downloading the secondary web page from the web server, and

(c) downloading said content to the second area within the primary web page.

A web server for allowing cross-communication between a first area and a second area of a primary web page respectively sourced by first and second content providers in accordance with the invention comprises:

a data access unit for accessing a primary web page containing a first area and a second area containing a link to a secondary web page accessible to said web server and containing a link to content from an unrestricted content provider, and

a communication unit coupled to the data access unit for conveying the primary web page to a client machine connected to the web server thus enabling said content to be loaded by a web browser in the client machine to the second area within the primary web page.

A web page configured according to the invention comprises a first area including a link to a secondary web page provided by a first content provider and containing a link to content from an unrestricted content provider embedded in the second area of the web page, thus enabling any content thereof to be loaded to the second area within the web page.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a pictorial representation showing the relationship between an advertiser and the various intermediaries that are responsible for conveying an advertisement to an end-user;

FIG. 2 shows pictorially the flow of data between the various elements shown in FIG. 1;

FIG. 3 is a pictorial representation of a system for carrying out the invention and comprising a web browser adapted to download content via the Internet from first and second content providers;

FIG. 4 is a schematic representation showing logical connections of different areas of a web page configured to allow cross-communication between first and second areas thereof;

FIG. 5 is a flow diagram showing the principal steps carried out by the system of FIG. 3;

FIG. 6 is a flow diagram showing the principal steps carried out by the web server in the system of FIG. 3;

FIG. 7 is a flow diagram showing the principal steps carried out by the web browser in the system of FIG. 3;

FIG. 8 is a block diagram showing functionally a web server for use with the system of FIG. 3;

FIG. 9 is a block diagram showing functionally a web browser for use with the system of FIG. 3;

FIG. 10 is a web page containing critical data that must be accessible;

FIG. 11 is a flowchart showing the principal steps carried out carried out by a web browser in a client machine in accordance with the invention for superimposing a graphic object on the web page shown in FIG. 10;

FIG. 12 is a flowchart showing the principal steps carried out by an applet in a client machine according to a specific implementation of the method depicted in FIG. 11;

FIG. 13 is a flowchart showing the principal steps carried out carried out by a creator of a host web page for allowing overlay of an independently distributed graphic object at a specified location on the web page; and

FIG. 14 is a block diagram showing functionally the principal components associated with a web browser used by a client machine for rendering a host web page in accordance with the invention.

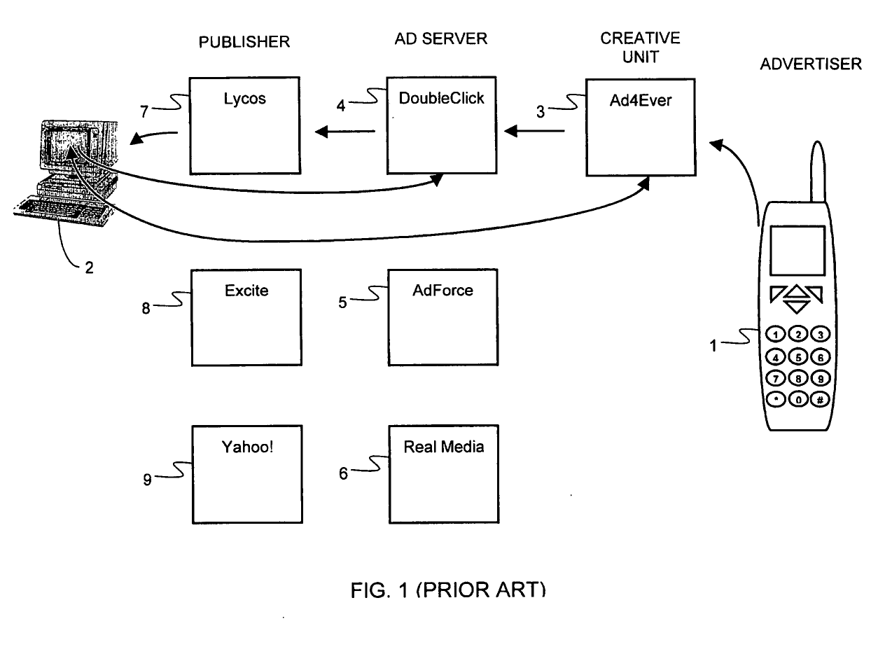

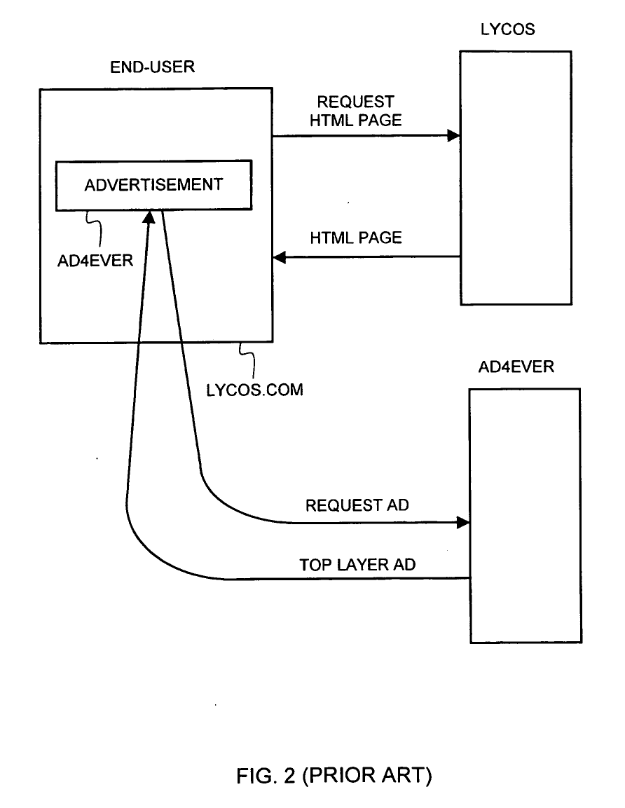

### DETAILED DESCRIPTION OF SPECIFIC EMBODIMENTS

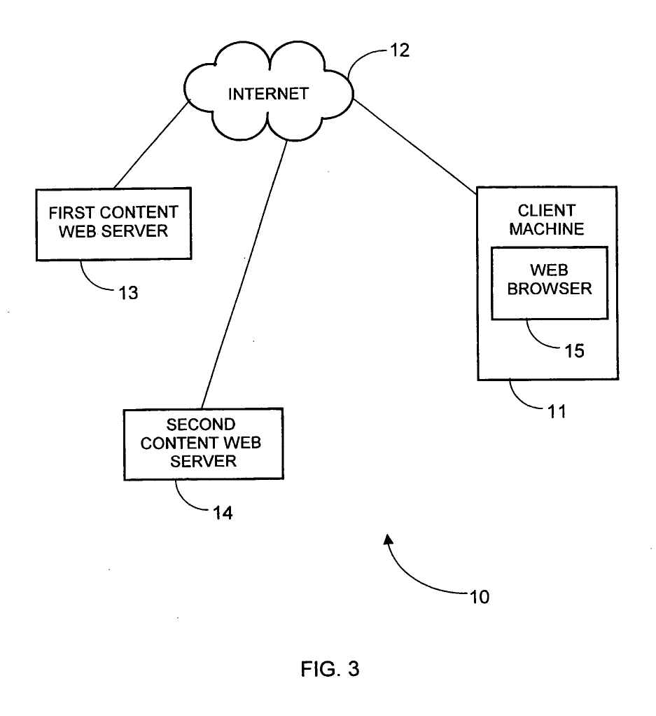

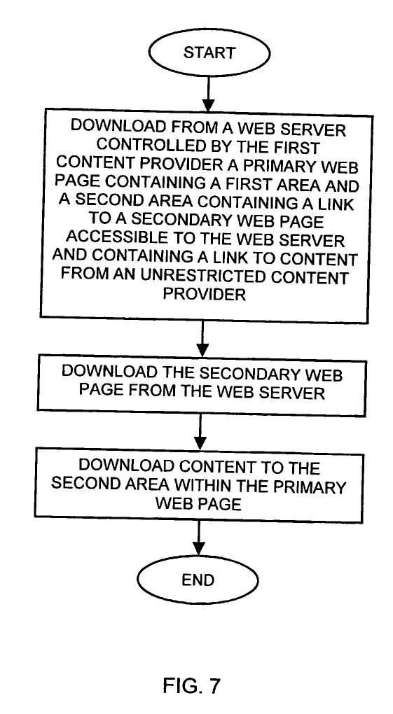

FIG. 3 shows a system depicted generally as 10 comprising a client machine 11 connected via the Internet 12 to a first content web server 13 and a second content web server 14. These may be the same web server but, for the purpose of the description, are assumed to be independent web servers. The client machine 11 includes a web browser 15 whose operation is shown schematically in FIG. 7 and is adapted to download content from the web servers 13 and 14. It will be understood that in practice a web page downloading from a web server may contain links to content from many different web servers and only two are shown for the sake of clarity.

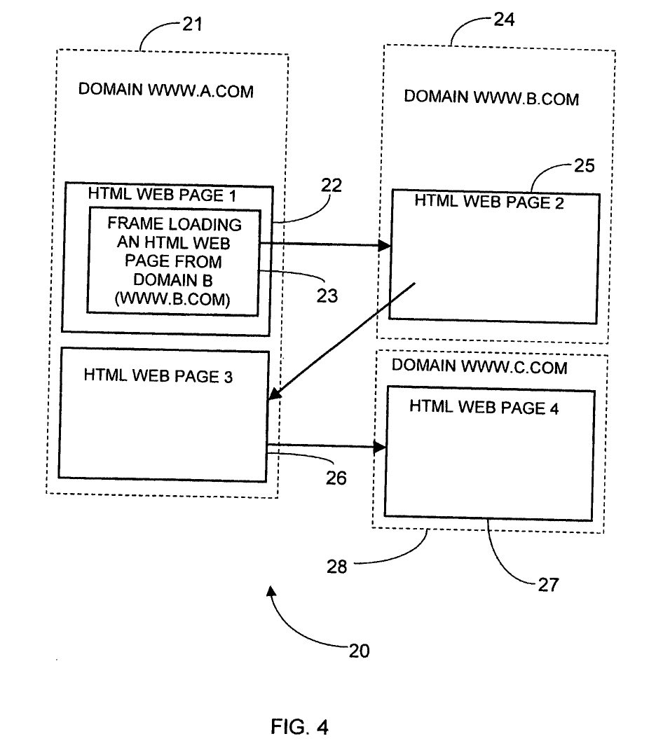

FIG. 4 shows schematically logical connections of different areas of a web page depicted generally as 20 configured to allow cross-communication between different areas thereof. A first area 21 contains a first web page 22 (constituting a primary web page) accessed from a first web server having a URL.WWWA.COM and itself containing a frame 23 constituting a second area. The frame includes a link to content that is accessed from a second web server 24 whose URL is WWW.B.COM. The second web server 24 stores a second web page 25 (constituting a secondary web page) that includes a link to a third web page 26 that is also stored on the first web server 21. The third web page 26 includes a link to a fourth web page 27 that is assumed to reside on a third web server 27 having a URL WWW.C.COM, which is independent of the first and second web servers 21 and 24.

Since the third web page 26 is loaded from the same web server 21 as the frame container of the second web page 25 constituted by the frame 23, it can communicate with the external frame container constituted by the first web page 22. That is to say, communication may occur between the frame 23 and the third web page 26 even though they are independent areas of the web page 20 and are accessed from different web servers. Moreover, the third web page 26 can load any HTML web page derived from any domain (such as the web page 27 resident on a completely different web server 26), and still fully communicate with the first web page 22, which is the original frame container for the second web page 23.

Communication between the web pages can include without limitation parameters and queries, and can initiate functions and procedures, as well reformatting etc. between the frame container 22 and the HTML residing within the frame 23, i.e. the second web page 25. If desired, the second web page 25 can appear on top of the container of the frame 23, thus superimposing a first web layer on a second web layer without being constrained to store the contents of both layers on the same web server. Visual elements served in the frame can appear outside of the boundaries of the frame and on top of the container of the frame and content can include rich-media, multimedia, video streams, voice streams etc. without limitation.

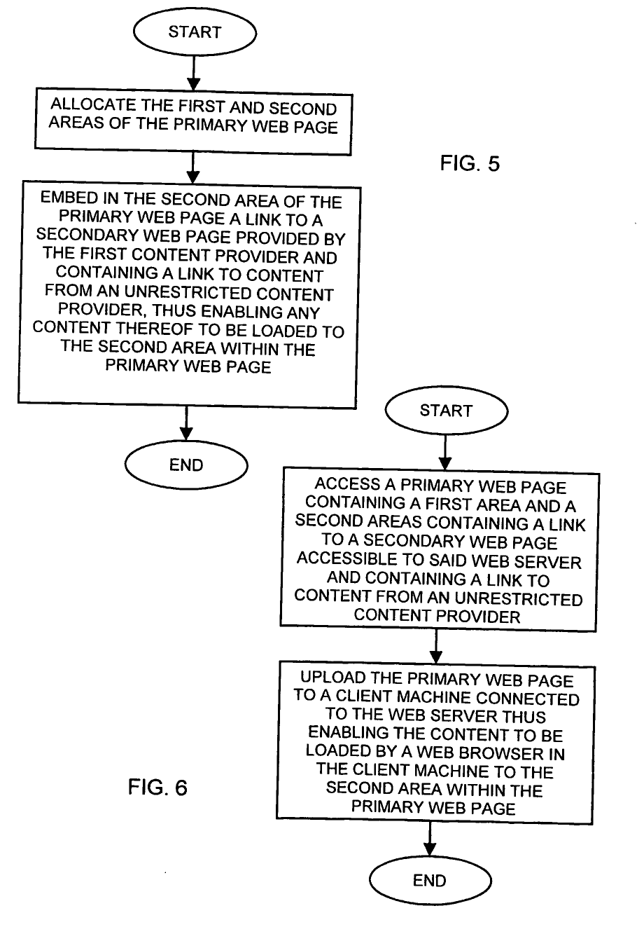

FIG. 5 is a flow diagram showing the principal steps carried out in a method and system for allowing cross-communication between first and second areas of a primary web page respectively sourced by first and second content providers. A web page designer allocates the first and second areas of the primary web page, and embeds in the second area of the primary web page a link to a secondary web page provided by the first content provider and containing a link to content from an unrestricted content provider, thus enabling any content thereof to be loaded to the second area within the primary web page.

FIG. 6 is a flow diagram showing the principal steps carried out by a web server operating on behalf of the first content provider. The web server accesses a primary web page containing a first area and a second area containing a link to a secondary web page accessible to said web server and containing a link to content from an unrestricted content provider. Typically the primary web page is stored on the web server, but it could be loaded on an auxiliary server that acts in tandem with the web server. Having accessed the primary web page, the web server uploads it to a client machine connected to the web server thus enabling the content to be loaded by a web browser in the client machine to the second area within the primary web page.

FIG. 7 is a flow diagram showing the principal steps carried out by a web browser in the client machine. The web browser downloads from the web server controlled by the first content provider a primary web page containing a first area and a second area containing a link to a secondary web page accessible to the web server and containing a link to content from an unrestricted content provider. It then downloads the secondary web page from the web server, and thereafter downloads the content to the second area within the primary web page.

In all the methods described above with reference to FIGS. 3, 4 and 5 of the drawings the second area is preferably an HTML frame within the primary web page. The first area is preferably an HTML frame within the primary web page. The first area may be the complete primary web page. The first and second content providers may or may not be different.

The content contained in the secondary web page may relate to an advertisement that is to be associated with the primary web page. The content contained in the secondary web page may be animated. The first and second areas may be overlapping HTML layers.

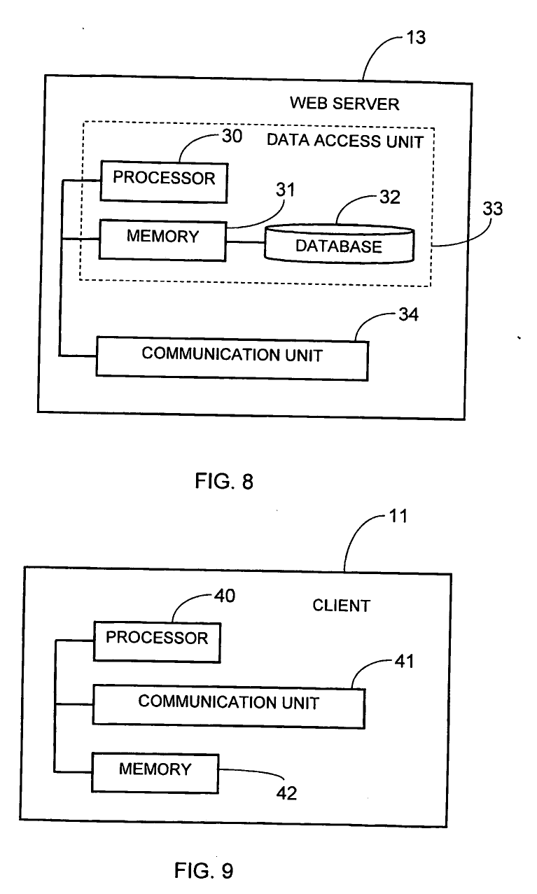

FIG. 8 shows functionally a web server 13 allowing cross-communication between first and second areas of a primary web page respectively sourced by first and second content providers. The web server comprises a processor 30 coupled to a memory 31 having access to a database 32 containing HTML web pages. The processor 30 operates to access requested primary web pages from the database 32 and in conjunction with the memory 31 and the database 32 constitutes a data access unit depicted as 33. Each primary web page contains a first area and a second area containing a link to a secondary web page that is accessible to the web server 13 and contains a link to content from an unrestricted content provider.

The web server 13 further includes a communication unit 34 coupled to the data access unit 33 for conveying the primary web page to the client machine 11 connected to the web server thus enabling the content to be loaded by a web browser in the client machine to the second area within the primary web page.

FIG. 9 shows functionally the principal components in a web browser within the client machine 11 for allowing cross-communication between first and second areas of a primary web page respectively sourced by first and second content providers. The client machine 11 comprises a processor 40 coupled to a memory 41 and to a communication unit 41 allowing communication with one or more web servers via the Internet. The processor 40 in conjunction with the memory 41 and the communication unit 41 performs the tasks of the web browser by:

(i) downloading from a web server controlled by the first content provider a primary web page containing a first area and a second area containing a link to a secondary web page accessible to said web server and containing a link to content from an unrestricted content provider,

(ii) downloading the secondary web page from the web server, and

(iii) downloading said content to the second area within the primary web page.

A web page allowing cross-communication between first and second areas thereof respectively sourced by first and second content providers, comprises a link to a secondary web page provided by the first content provider and containing a link to content from an unrestricted content provider embedded in the second area of the web page, thus enabling any content thereof to be loaded to the second area within the web page.

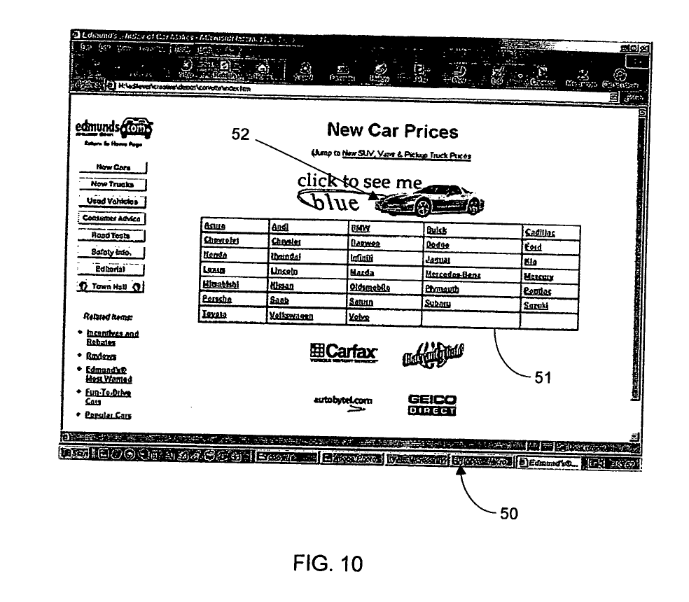

FIG. 10 shows a web page 50 containing a table 51 containing critical data to the web page. By “critical” is meant that the table 51 contains links to subsidiary web pages that must be selectable by the end-user. Likewise, the table could be a menu containing user options that must be selectable at all times or even non-selectable data that must nevertheless be readable at all times, such as instructions, help information and the like. To this end, the table 51 must not be obscured by an object superimposed on the web page 50 such as might be sent to the client machine by an independent content provider. Such an object may be a graphic advertisement object 52 (constituting a first object) that is embedded in the web page 50, on top of the table 51 (constituting a second object) and must be located in such a way that it does not obscure or overlay any other object that exists in the table 51.

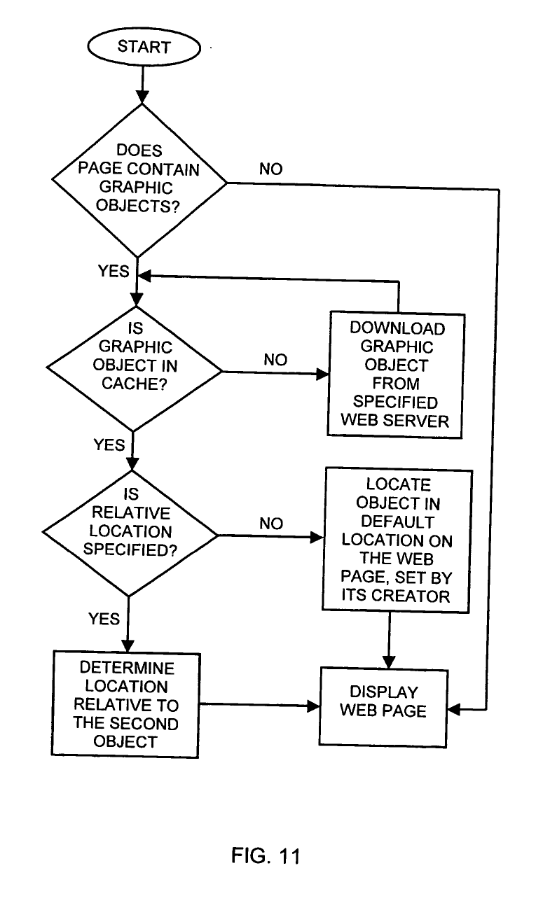

FIG. 11 is a flow diagram showing the principal operating steps carried by a client machine having a web browser program, upon downloading a web page. The client machine checks whether named objects are referred to by the web page. A page containing no named graphic object is displayed using any conventional method known in the art. For every named object contained within the web page, the browser checks whether the object is already loaded in cache on the client machine. If it is not yet loaded, the client machine accesses the object's web server and downloads it.

When the object is loaded on the client machine, the client machine checks within the web page source for location data associated with an object having the same name as the object 52. If no location is specified, the object is located at the default location, specified by the object's creator. Otherwise, the location specified in the web page source for the named object is used to set the object's location in the web page.

When all the named objects are loaded and their locations are set, the web page is ready for display.

In the particular scenario described in above-referenced WO 01/44969, the first object 52 is an advertisement layer having three time-separated components:

1. The teaser—a quick teaser to grab the user's attention;

2. The reminder—a link to a main movie that serves as a reminder to enable the user to reach the main movie, i.e. the main advertisement; and

3. The main movie—if the user clicks on the reminder, a main movie opens up with interactive abilities, e-commerce abilities etc.

Not all three components are mandatory, although they do exist in most cases. The invention enables the website to decide where each component of the advertisement layer will be located and displayed on the screen/HTML page. Thus, as explained above with reference to FIG. 11, all that needs to be done to the HTML code of the host web page is to name an existing tag on the HTML page by a specific predefined ID. To define the location of the reminder associated with the advertisement layer, any tag in the HTML page must given the following ID:

ID=‘AD4EVER_REMINDER_POSITION’

assuming that the reminder component is identified by the advertisement content provider as AD4EVER_REMINDER_POSITION. In this context, it should be understood that there is no need specifically to identify the destination location of the reminder component, since its location defaults to that of the existing tag with which it is associated. However, as will be explained in an example below, if required a different location may indeed be specified.

To define the location of the main movie component of the advertisement layer, any tag in the HTML page must given the following ID:

ID=‘AD4EVER_MAIN_POSITION’

assuming that the main movie component is identified by the advertisement content provider as AD4EVER_MAIN_POSITION.

In order to control the location of the ad component displayed on the end-user's web browser, the web browser must be adapted to relocate animated objects uploaded by an independent content provider and each having a respective name corresponding to an ID of an object in the HTML code of a host web page in association with which the animated objects are to be displayed. This is done by interaction of the creative part of the advertisement with an applet that resides in the browser. In accordance with the invention, many elements are downloaded to the end-user's browser, including a Java applet, a JavaScript script and interactive elements that contain the creative and rich media parts of the animated advertisement layer. Java is a registered trademark of Sun Microsystems Ltd. The Java applet controls and instructs the creative elements where they must be located by the end-user's browser, thus enabling the ad to locate itself based on obtaining the location from the HTML page itself upon which it displays.

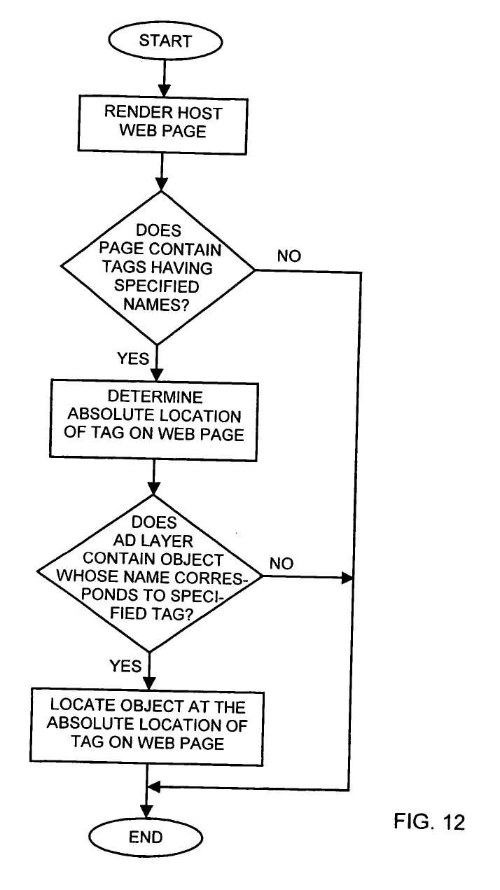

FIG. 12 is a flow diagram showing that the principal steps carried out by the applet are as follows:

1. The Java applet that controls the location of the creative elements renders the HTML page.

2. By rendering the HTML page, the Java applet looks in all the browser's windows (including tables, frames, I-Frames and external open windows) for specific predefined ID names.

3. For each tag with the predefined ID thus found, the Java applet obtains its unique and absolute location on the page.

4. Once the absolute location is obtained of the tags containing the animated object in the advertisement layer location ID, the Java applet instructs the creative elements of the animated objects to locate themselves according to the absolute location of the tag (and according to the absolute location it obtained). The tag is provided in the HTML code of the host web page and generally, after rendering by the browser in the client machine, gives rise to content that appears on a layer that appears behind the advertisement layer containing the animated object.

5. The creative elements will automatically locate accordingly, such that the animated object in the animated advertisement layer is located directly above the HTML element that has given the unique predefined ID mentioned above.

6. In addition, an animated advertisement layer may theoretically be built from infinite parts that can continue endlessly. Therefore, every part has a unique predefined ID name, and every ID name can be given to different tags in the HTML page.

By such means, every object in the animated advertisement layer can appear in its proprietary location, according to where the HTML tag containing the appropriate ID resides on the HTML page.

### EXAMPLE 1

```
<HTML>
  <HEAD>
    <!— html of head here →
  </HEAD>
  <BODY>
    <!— html of body here →
    <!—in the case where we want to locate the reminder part of the
    advertisement layer above a specific image, the following line
    demonstrates how to do it→
    <IMG ID=‘AD4EVER_REMINDER_POSITION’ src=“xyz.gif”>
  </BODY>
</HTML>
```

In the above example, the reminder part of the animated advertisement layer will appear directly above the defined image.

### EXAMPLE 2

```
<HTML>
  <HEAD>
    <!— html of head here →
  </HEAD>
  <BODY>
    <!— html of body here →
    <IMG src=“image1.gif”>
    <IMG ID=‘AD4EVER_REMINDER_POSITION’ src=“
  image2.jpg”>
    <IMG src=“ image3.bmp”>
    <TABLE ID=‘AD4EVER_MAIN_POSITION’ width=130
  border=0>
      <TBODY>
        <TR vAlign=bottom>
          <TD width=4 height=1>
          </TD>
        </TR>
      </TBODY>
    </TABLE>
  </BODY>
</HTML>
```

In the above example, the reminder part of the animated advertisement layer will appear directly above the defined image (‘image2.jpg’), and the main movie (a specific part of the animated advertisement layer) will appear directly above a specific table (identified by the TABLE tag) on the HTML page.

In the case where there is no specification as to where locate the animated object in the animated advertisement layer, it will be located in a default location hard-coded within the object itself. The default location may be defined by defined by the publisher or by the advertiser.

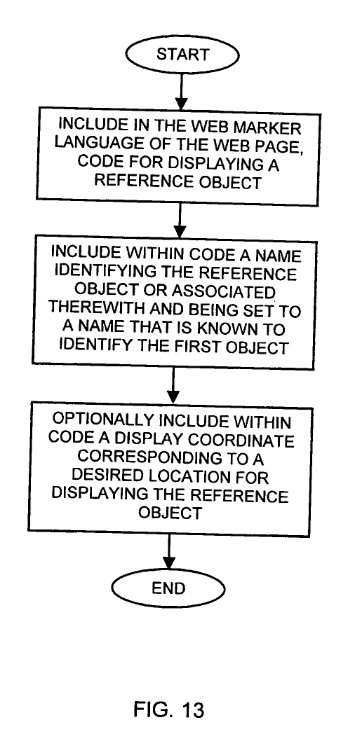

FIG. 13 is a flow diagram showing the principal steps a creator of a host web page for allowing overlay of an independently distributed graphic object at a specified location on the web page. Code in the web page is adapted for displaying a reference object is included in the web marker language of the web page, and within the code there is included a name identifying the reference object or being associated therewith and being set to a name that is known to identify the first object. The code may also be adapted to include a display coordinate corresponding to the desired location for displaying the reference object, although this is not necessary and in the absence thereof, the display location of the reference object defaults to the location of a tag in the host web page with which the reference object is associated. By such means, the creator can introduce a tag into the HTML code of the host page whose sole purpose is to act as an anchor for the reference object and is not itself rendered by the web browser in the client machine as a separate displayable object. Alternatively, the creator of the web page can exploit an existing tag in the HTML code of the web page and can modify the HThL code associated with this tag so as to reference a named object that will be uploaded to the client machine independently and will be displayed by the web browser in the client machine at the location associated with the tag in the HTML code of the web page. However, the creator of the web page can also modify the code still further by including, in addition to the name of the reference object, also a desired location. In this case, the named object will displayed at the specified location, overriding not only any default location embedded in the object itself by the object's creator, but also any default location of the tag in the HTML code of the web page associated with the reference object.

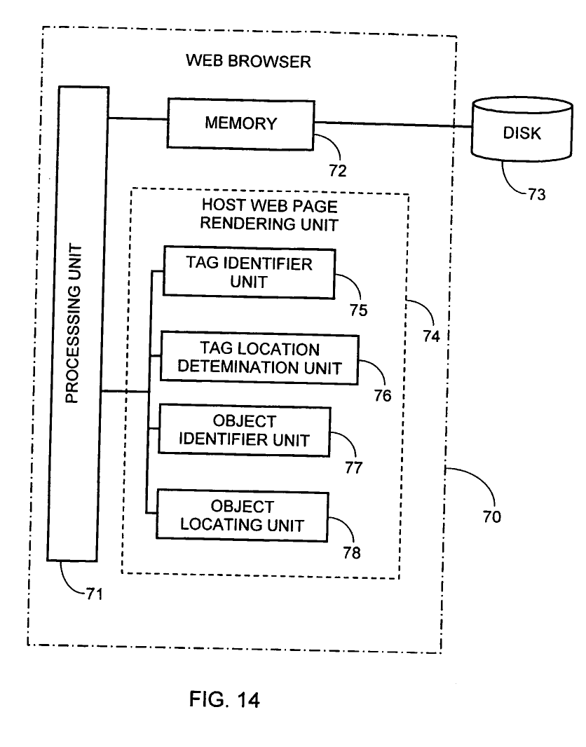

FIG. 14 is a block diagram showing functionally the principal components associated with a web browser 70 used by a client machine for rendering a host web page in accordance with the invention. The web browser 70 operates in conjunction with a processing unit 71 coupled to a memory 72 having access to an external memory source such as disk 73 in which there may be stored names identifying the reference objects or being associated therewith and each being set to a respective name that is known to identify objects that will be externally sourced, typically by an independent content provider.

Also coupled to the processing unit 71 is a host web page rendering unit 74 for rendering the host web page. The host web page rendering unit 74 includes a tag identifier unit 75 for looking in all the browser's windows (including tables, frames, I-Frames and external open windows) for specific predefined ID names stored in the memory 72 or the disk 73. A tag location determination unit 76 is responsively coupled to the tag identifier unit 75 for determining the unique and absolute location on the page of each tag with the predefined ID thus found by the tag identifier unit 75.

An object identifier unit 77 identifies objects, typically downloaded by the client machine from an independent content provider, such as an ad server, whose names correspond to the name of a reference object derived by the tag identifier unit 75. An object locating unit 78 is coupled to the object identifier unit 77 for locating objects thus identified by the object identifier unit 77 according to the absolute location of the tag whose ID corresponds to the name of the object.

Typically, the host web page rendering unit 74 is implemented in software using an agent that may be a Java applet. Use of such an applet obviates the need for customization of the client machine's web browser, although it will be appreciated that a customized web browser could be used instead.

It will be appreciated that the invention is applicable to a large number of applications, some of which are described. However, no restriction on the type of application to which the technique of the invention is applied is intended and thus whilst a particular example has been described with regard to an animation layer for depicting an advertisement moving on top of a host layer, the principles of the invention are equally applicable to other environments as will be apparent to those skilled in the art.

It will also be understood that such a modified web browser or applet according to the invention may also be implemented using a suitably programmed computer. Likewise, the applet or customized web browser may be a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A method for allowing cross-communication between a first area (21) and a second area (23) of a primary web page (22) respectively sourced by different first and second content providers, said method characterized by:
(a) allocating the first and second areas of the primary web page, and
(b) embedding in the second area of the primary web page a link to a secondary web page provided by the first content provider and containing a link to content from an unrestricted content provider, thus enabling any content thereof to be loaded to the second area within the primary web page.

2. The method according to claim 1, wherein the second area is an HTML frame within the primary web page.

3. The method according to claim 1, wherein the first area is an HTML frame within the primary web page.

4. The method according to claim 1, wherein the first area is the complete primary web page.

5. The method according to claim 1, wherein the content contained in the secondary web page relates to an advertisement that is to be associated with the primary web page.

6. The method according to claim 1, wherein the content contained in the secondary web page is animated.

7. The method according to claim 1, wherein the first and second areas are overlapping HTML layers.

8. A method for allowing cross-communication between a first area and a second area of a primary web page respectively sourced by different first and second content providers, said method characterized by:
(a) accessing a primary web page (22) containing a first area (21) and a second area (23) containing a link to a secondary web page accessible to a web server (13) and containing a link to content from an unrestricted content provider (14), and
(b) uploading the primary web page from the web server to a client machine (11) connected to the web server thus enabling said content to be loaded by a web browser (15) in the client machine to the second area within the primary web page.

9. The method according to claim 8, wherein the second area is an HTML frame within the primary web page.

10. The method according to claim 8, wherein the first area is an HTML frame within the primary web page.

11. The method according to claim 8, wherein the first area is the complete primary web page.

12. The method according to claim 8, wherein the content contained in the secondary web page relates to an advertisement that is to be associated with the primary web page.

13. The method according to claim 8, wherein the content contained in the secondary web page is animated.

14. The method according to claim 8, wherein the first and second areas are overlapping HTML layers.

15. The method according to claim 8, further including for locating a first object at a desired location with respect to a web page encoded using a web marker language, so that when the first object is displayed by a client machine having a web browser in mutual association with the web page the first object is spatially coordinated with a second object in the web page, and said method further comprising:
(a) including within the web marker language of the web page, code for displaying a reference object, and
(b) including within said code a name identifying the reference object or being associated therewith and being set to a name that is known to identify the first object;
whereby upon uploading the web page to the client machine that receives the first object the web browser displays the first object at a display coordinate of the reference object.

16. The method according to claim 15, wherein the reference object is a tag in the web page.

17. The method according to claim 15, wherein said first and second objects are derived from mutually independent sources.

18. The method according to claim 15, further including:
(c) including within said code a display coordinate corresponding to said desired location for displaying the reference object.

19. The method according to claim 15, wherein the first object is an animated object.

20. The method according to claim 15, wherein the first object is overlaid on a separate layer to the web page.

21. The method according to claim 15, wherein the first object is an advertisement object.

22. The method according to claim 21, wherein the advertisement object includes a link to an advertisement and serves as a permanent reminder of a brief animated advertisement clip previously displayed intermittently.

23. A method for allowing cross-communication between a first area and a second area of a primary web page respectively sourced by different first and second content providers, said method characterized by:
(a) downloading from a web server (13) controlled by the first content provider a primary web page (22) containing a first area (21) and a second area (23) containing a link to a secondary web page (25) accessible to said web server and containing a link to content from an unrestricted content provider, and
(b) downloading the secondary web page from the web server, and
(c) downloading said content to the second area within the primary web page.

24. The method according to claim 23, wherein the second area is an HTML frame within the primary web page.

25. The method according to claim 23, wherein the first area is an HTML frame within the primary web page.

26. The method according to claim 23, wherein the first area is the complete primary web page.

27. The method according to claim 23, wherein the content contained in the secondary web page relates to an advertisement that is to be associated with the primary web page.

28. The method according to claim 23, wherein the content contained in the secondary web page is animated.

29. The method according to claim 23, wherein the first and second areas are overlapping HTML layers.

30. The method according to claim 16, being further adapted for rendering a first object at a desired location with respect to a web page encoded using a web marker language, so that when the first object is displayed in mutual association with the web page in spatial coordination with a second object in the web page, and said method further comprising:
(d) deriving specific predefined names referenced in all the web browser's windows,
(e) determining the unique and absolute location on the page of each reference object with the predefined name,
(f) identifying objects whose names correspond to the predefined name of one of the reference objects, and
(g) locating objects thus identified according to the absolute location of the tag whose name corresponds to the name of the object;
whereby upon rendering the web page and the first object, the first object is displayed at a display coordinate of the reference object.

31. The method according to claim 30, wherein the reference object is a tag in the web page.

32. The method according to claim 30, wherein said first and second objects are derived from mutually independent sources.

33. The method according to claim 30, wherein the first object is an animated object.

34. The method according to claim 30, wherein the first object is overlaid on a separate layer to the web page.

35. The method according to claim 30, wherein the first object is an advertisement object.

36. The method according to claim 35, wherein the advertisement object includes a link to an advertisement and serves as a permanent reminder of a brief animated advertisement clip previously displayed intermittently.

37. A web server (13, 14) for allowing cross-communication between a first area and a second area of a primary web page respectively sourced by different first and second content providers, said web server comprising:
a data access unit (33) for accessing a primary web page containing a first area and a second area containing a link to a secondary web page accessible to said web server and containing a link to content from an unrestricted content provider, and
a communication unit (34) coupled to the date access unit for conveying the primary web page to a client machine connected to the web server thus enabling said content to be loaded by a web browser in the client machine to the second area within the primary web page.

38. A web browser (15, 70) allowing cross-communication between a first area and a second area of a primary web page respectively sourced by different first and second content providers, said web browser being adapted to:
(a) download from a web server controlled by the first content provider a primary web page (22) containing a first area (21) and a second area (23) containing a link to a secondary web page (25) accessible to said web server and containing a link to content (26) from an unrestricted content provider,
(b) download the secondary web page from the web server, and
(c) download said content to the second area within the primary web page.

39. A web page rendering unit (74) for use by the web browser (70) according to claim 17 for rendering a first object at a desired location with respect to a web page encoded using a web marker language, so that the first object is displayed in mutual association with the web page in spatial coordination with a second object in the web page, said web page rendering unit comprising:
a tag identifier unit (75) for deriving specific predefined names referenced in all the browser's windows,
a tag location determination unit (76) responsively coupled to the tag identifier unit (75) for determining the unique and absolute location on the page of each tag with the predefined ID thus found by the tag identifier unit (75),
an object identifier unit (77) for identifying objects whose names correspond to the name of a reference object derived by the tag identifier unit (75), and
an object locating unit (78) coupled to the object identifier unit (77) for locating objects thus identified by the object identifier unit (77) according to the absolute location of the tag whose ID corresponds to the name of the object.

40. The web page rendering unit according to claim 39, wherein the tag identifier unit (75) is adapted to obtain said predefined names by accessing a memory (52, 53).

41. The web page rendering unit according to claim 39, wherein the reference object is a tag in the web page.

42. The web page rendering unit according to claim 39, wherein said first and second objects are derived from mutually independent sources.

43. The web page rendering unit according to claim 39, wherein the first object is an animated object.

44. The web page rendering unit according to claim 39, wherein the first object is overlaid on a separate layer to the web page.

45. The web page rendering unit according to claim 39, wherein the first object is an advertisement object.

46. The web page rendering unit according to claim 45, wherein the advertisement object includes a link to an advertisement and serves as a permanent reminder of a brief animated advertisement clip previously displayed intermittently.

47. A web page (20) allowing cross-communication between a first area (21) and a second area (23) thereof respectively sourced by different first and second content providers, said web page (20) comprising:
a link to a secondary web page (25) provided by the first content provider and containing a link to content from an unrestricted content provider embedded in the second area of the web page, thus enabling any content thereof to be loaded to the second area within the web page.

48. The web page according to claim 47, further including:
code in the web marker language of the web page for displaying a reference object, and
a name within said code identifying the reference object or being associated therewith and being set to a name that is known to identify the first object;
whereby upon uploading the web page to the client machine that receives the first object, the web browser displays the first object at a display coordinate of the reference object.

49. The web page according to claim 47, wherein the reference object is a tag in the web page.

50. A method for allowing cross-communication between a first area (21) and a second area (23) of a primary web page (22) respectively sourced by different first and second content providers, said method characterized by:
(a) configuring both the first and second area for receiving content from the first content provider by embedding in the second area of the primary web page a link to a secondary web page provided by the first content provider, and
(b) including in the secondary web page a link to content from an unrestricted content provider, thus enabling any content thereof to be loaded to the second area within the primary web page while allowing cross-communication between the secondary web page and the first area of the primary web page.

51. The method according to claim 23, being further adapted for rendering a first object at a desired location with respect to a web page encoded using a web marker language, so that when the first object is displayed in mutual association with the web page in spatial coordination with a second object in the web page, and said method further comprising:
(d) deriving specific predefined names referenced in all the web browser's windows,
(e) determining the unique and absolute location on the page of each reference object with the predefined name, and
(f) identifying objects whose names correspond to the predefined name of one of the reference objects, and
(g) locating objects thus identified according to the absolute location of the tag whose name corresponds to the name of the object;
whereby upon rendering the web page and the first object, the first object is displayed at a display coordinate of the reference object.
